(19) United States
(12) Patent Application Publication
(10) Pub. No.: US 2010/0328441 A1
(43) Pub. Date: Dec. 30, 2010

(54) VIDEO DISPLAY DEVICE

(75) Inventor: Naoyuki Wada, Fuchu-shi (JP)

Correspondence Address: KNOBBE MARTENS OLSON & BEAR LLP, 2040 MAIN STREET, FOURTEENTH FLOOR, IRVINE, CA, 92614, US

(73) Assignee: KABUSHIKI KAISHA TOSHIBA, Tokyo (JP)

(21) Appl. No.: 12/791,710

(22) Filed: Jun. 1, 2010

(30) Foreign Application Priority Data
Jun. 26, 2009 (JP) 2009-151849

(51) Int. Cl. H04N 7/18

(52) U.S. Cl. 348/61; 348/E07.091

(57) ABSTRACT

A video display device includes: a connection detecting module configured to detect whether a shutter glasses is connected to the device; a generation module configured to generate a second frame, which is alternately displayed with a first frame included in a video content, by adding an irregular pattern to an image viewed in a predetermined color when the connection detecting module detects that the shutter glasses is connected; a display unit configured to display the video content; a video display controller configured to control the display unit to alternately display the first frame and the second frame; and a shutter glasses controller configured to control the shutter glasses to close shutters in synchronization with the time for displaying the second frame.

### CROSS REFERENCE TO RELATED APPLICATION(S)

The present disclosure relates to the subject matters contained in Japanese Patent Application No. 2009-151849 filed on Jun. 26, 2009, which are incorporated herein by reference in its entirety.

### FIELD

The present invention relates to a video display device.

### BACKGROUND

Video display devices that alternately display an image including confidential information and an image including non-confidential information and allow easy recognition of the image including the non-confidential information while acquiring the confidentiality for the confidential information have been known.

For example, a video display device disclosed in JP-A-7-219489 includes a first VRAM that outputs a video signal of an image including confidential information, a second VRAM that outputs a video signal of an image including non-confidential information, a random signal generating circuit that randomly generates two types of signals, a switch unit that outputs a video signal by switching between the first VRAM and the second VRAM in synchronization with a signal from the random signal generating circuit, a luminance-level converting circuit that converts the luminance level of a video signal of an image including non-confidential information so as to be increased, and shutter glasses that open or close the shutters in synchronization with a signal from the random signal generating circuit. Accordingly, only the image including the confidential information can be presented to a user who wears the shutter glasses. On the other hand, the images can be presented to a user who does not wear the shutter glasses such that the image including non-confidential information having a high luminance level can be easily seen and the image including the confidential information cannot be easily seen.

However, according to the above-described conventional video display device, a user is required to switch between the time for handling an image including confidential information and the time for not handling the image including confidential information. Accordingly, the user is required to perform the switch procedure is additionally.

### BRIEF DESCRIPTION OF THE DRAWINGS

A general configuration that implements the various feature of the invention will be described with reference to the drawings. The drawings and the associated descriptions are provided to illustrate embodiments of the invention and not to limit the scope of the invention.

FIG. 1 is a schematic diagram representing an example of the configuration of a video display device according to an embodiment of the present invention.

FIG. 2 is a schematic diagram showing an example of the configuration of a video display device according to the embodiment of the invention.

FIG. 3 is a schematic diagram representing an example of the configuration of liquid crystal shutter glasses according to the embodiment of the present invention.

FIGS. 4A and 4B are schematic diagrams showing examples of the configuration of a display image according to the embodiment of the present invention.

FIGS. 5A and 5B are schematic diagrams representing examples of combination of display of the video display device according to the embodiment of the present invention and the shutter operation of liquid crystal shutter glasses.

FIG. 6 is a schematic diagram representing an example of the operation of a video display device according to the embodiment of the present invention.

### DETAILED DESCRIPTION OF THE EMBODIMENTS

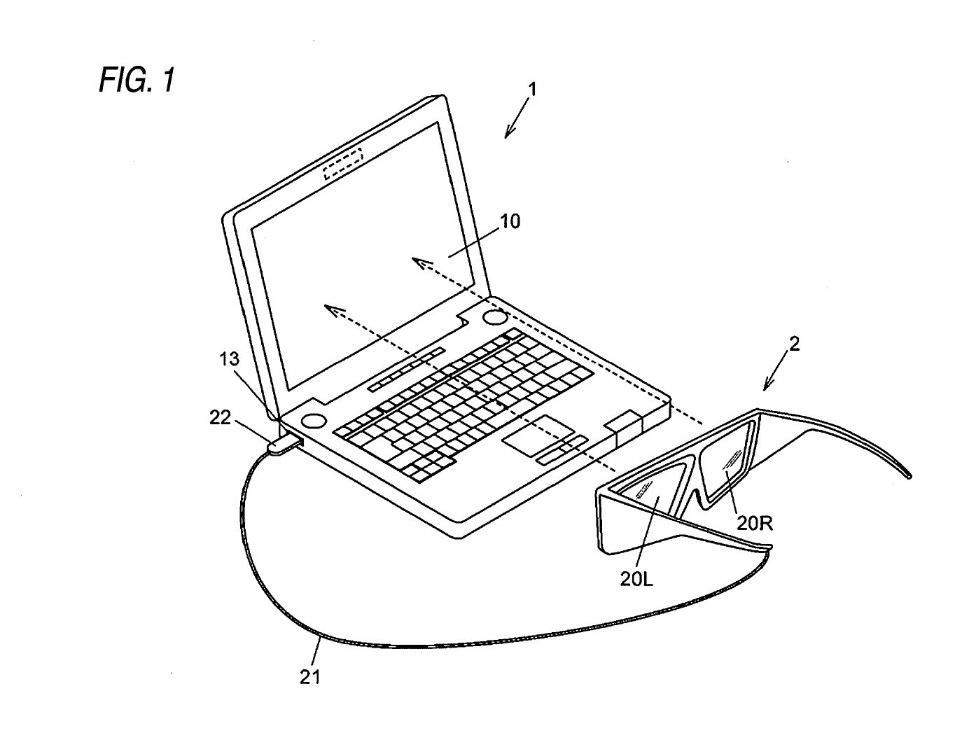

FIG. 1 is a schematic diagram representing an example of the configuration of a video display device according to an embodiment of the present invention.

The video display device 1, for example, is an information processing device such as a personal computer that is configured with electronic components such as a CPU (Central Processing Unit) and an HDD (Hard Disc Drive). The video display device 1 includes a display unit 10 that is configured by an LCD (Liquid Crystal Display) panel for displaying a video and a USB port 13 into which a USB plug 22 having liquid crystal shutter glasses 2 connected thereto is inserted. The display unit 10 displays a video in synchronization with the shutter operation of the liquid crystal shutter glasses 2 to be described later.

The liquid crystal shutter glasses 2 includes lenses 20L and 20R that include liquid crystal shutters for controlling the fields of visions of user's left and right eyes, a cable 21 that communicates with the video display device 1 for information, and a USB (Universal Serial Bus) plug 22 that is connected to the USB port 13 of the video display device 1. A user wearing the liquid crystal shutter glasses 2 views a video displayed in the display unit 10 of the video display device 1 through the lenses 20L and 20R.

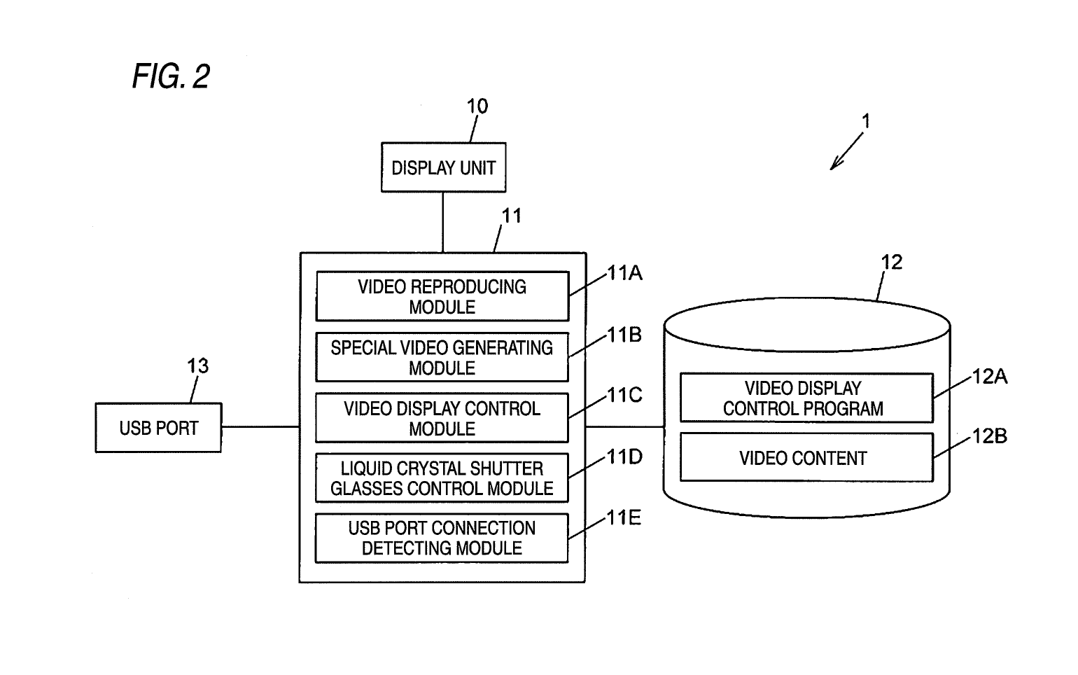

FIG. 2 is a schematic diagram showing an example of the configuration of a video display device according to the embodiment.

The video display device 1 includes a display unit 10 that is configured by an LCD and the like and displays a video, a controller 11 that is configured by a CPU and the like, a memory 12 that is configured by an HDD and the like, and a USB port 13 that communicates with an external device having a USB plug for information.

The controller 11 includes a video reproducing module 11A that reproduces a video content 12B to be described later, a special video generating module 11B for generating a special video that is inserted into the video content, so that the content is not known to any person other than the user wearing the liquid crystal shutter glasses 2 at the time of reproducing the video content including confidential information, a video display control module 11C that controls the video display of the display unit 10, a liquid crystal shutter glasses control module 11D that controls the operation of the liquid crystal shutter of the liquid crystal shutter glasses 2, and a USB port connection detecting module 11E that detects an external device connected to the USB port 13.

The memory 12 has a video display control program 12A that allows the controller 11 to operate as the video reproducing module 11A, the special video generating module 11B, the video display control module 11C, the liquid crystal shutter glasses control module 11D, and the USB port connection detecting module 11E and a video content 12B that includes an ordinary video, a 3D display video, confidential information, and the like.

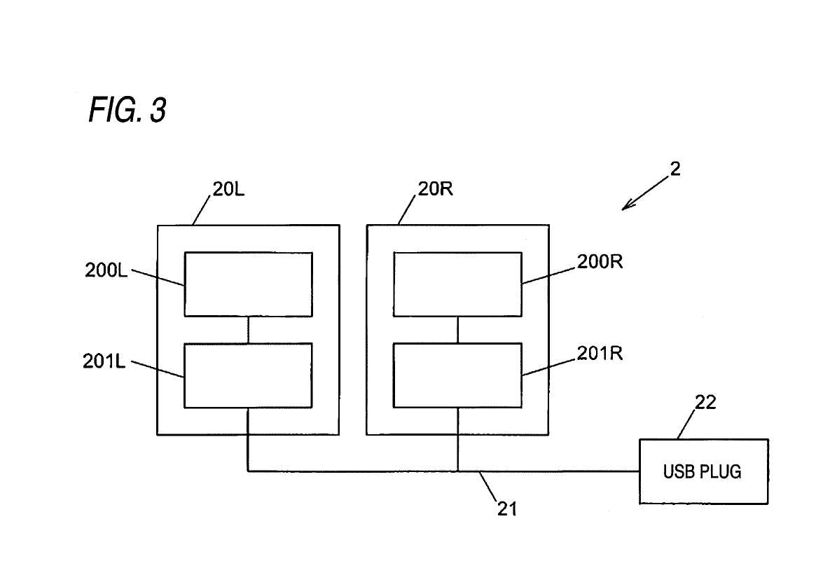

FIG. 3 is a schematic diagram representing an example of the configuration of liquid crystal shutter glasses according to the embodiment of the present invention.

The liquid crystal shutter glasses 2 include the lens 20L that has a liquid crystal shutter 200L and a shutter driving module 201L, the lens 20R that has a liquid crystal shutter 200R and a shutter driving module 201R, a cable 21 that is used for transmitting driving information of the liquid crystal shutter, and the USB plug 22 that is connected to the USB port 13 of the video display device 1.

The liquid crystal shutters 200L and 200R are driven by the shutter driving modules 201L and 201R. The liquid crystal shutters 200L and 200R repeats shuttering, for example, at the frequency of about 60 Hz. The liquid crystal shutters 200L and 200R are driven independently. The method of driving the liquid crystal shutters 200L and 200R will be described later.

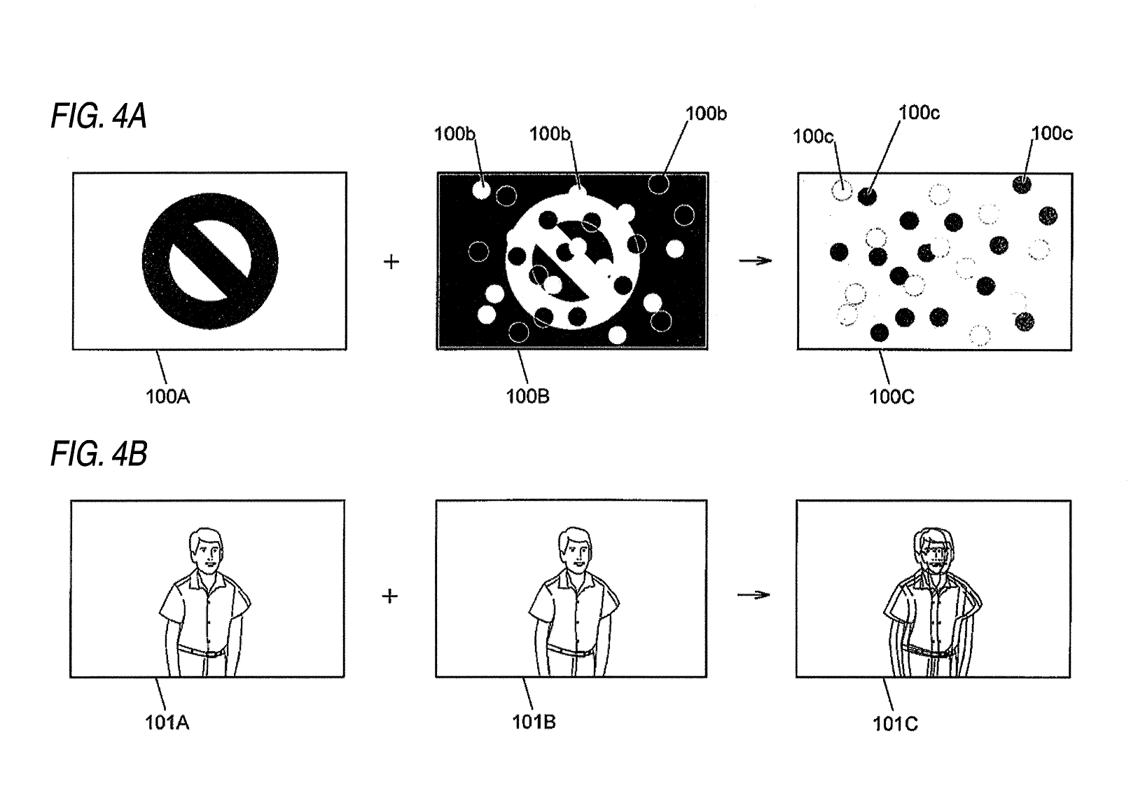

FIG. 4 is a schematic diagram showing an example of the configuration of a display image according to the embodiment.

The image 100A including confidential information, as represented in FIG. 4A, is alternately displayed with an image 100B in which random dots 100b are included in the image 100A of which the colors are inverted. Accordingly, the image 100A is recognized as the image 100A by a user who wears the liquid crystal shutter glasses 2 by having the image 100B be invisible by using the liquid crystal shutter. On the other hand, the image 100A is recognized as an image 100C including the random dots 100c by a user who does not wear the liquid crystal shutter glasses 2.

Hereinafter, a method of generating the image 100B will be described. First, the color of each pixel of the image 100A is CA=αAR+βAG+γAB by using RGB. Here, the white color is assumed to be CA=1R+1G+1B, and the black color is assumed to be CA=0R+0G+0B. Next, when the color desired to be output at the time of combining two images is determined to be CC=αCR+βCG+γCB in advance, the color of each pixel of the image 100B is determined to be CB=(αC−αA)R+(βC−βA)G+(γC−γA)B. In addition, by setting one color of the random dot 100b of the image 100B to CDB1=(2αC−αA)R+(2βC−βA)G+(2γC−γA)B and setting the other color of the random dots 100b to CDB2=(½αC−αA)R+(½βC−βA) G+(½γC−γA)B, the colors of the random dots of the image 100C become CDC1=2αcR+2βcG+2γcB and CDC2=½αcR+½βcG+½γcB

In addition, as represented in FIG. 4B, the images 101A and 101B forming a 3D image are displayed in an alternating manner. By having the image 101A be invisible to the right eye and the image 101B be invisible to the left eye of a user who wears the liquid crystal shutter glasses 2, the images 101A and 101B are recognized as a 3D image. On the other hand, the images 101A and 101B are recognized to be an image 101C in which images are deviated from each other by a user who does not wear the liquid crystal shutter glasses 2.

Hereinafter, the operation of a video display device according to the embodiment of the present invention will be described with reference to drawings.

First, a user reproduces the video content 12B by operating the video display device 1. Depending on the type of the video content 12B to be reproduced, the video display device 1 and the liquid crystal shutter glasses 2 are operated as described below.

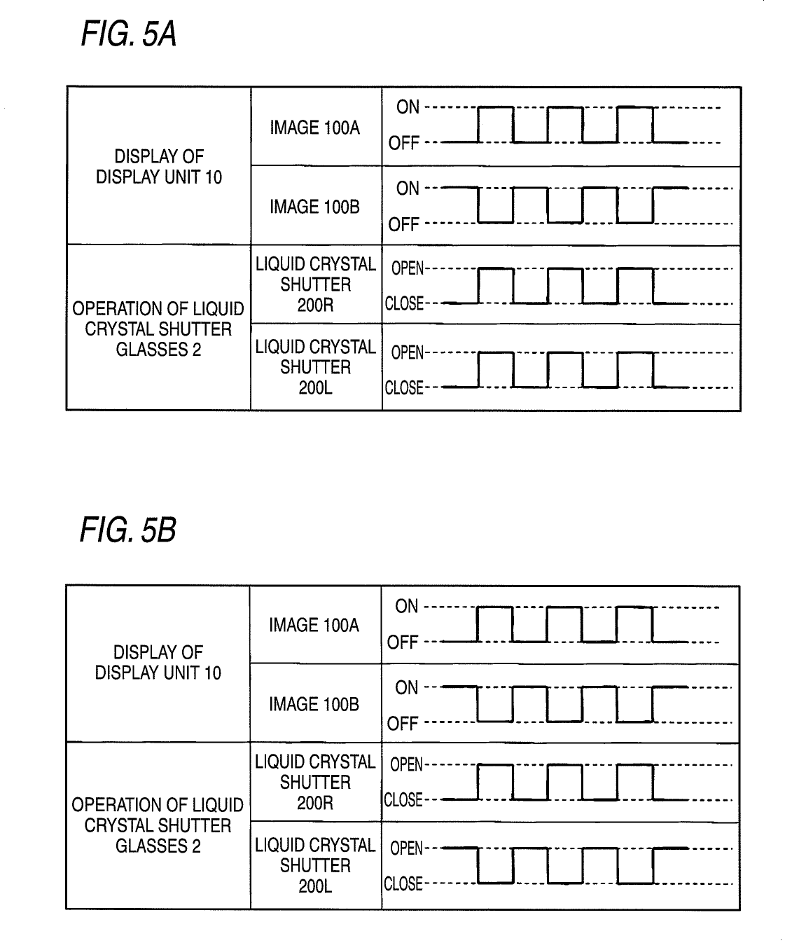

FIG. 5 is a schematic diagram representing an example of combination of display of the video display device according to the embodiment of the present invention and the shutter operation of liquid crystal shutter glasses.

When the images 100A and 100B represented in FIG. 4A are to be displayed, the images 100A and 100B are displayed in an alternating manner as represented in FIG. 5A. In addition, in accordance with the display of the images 100A and 100B, the liquid crystal shutters 200L and 200R open the shutters at the time when the image 100A is displayed, and the liquid crystal shutters 200L and 200R close the shutters at the time when the image 100B is displayed.

On the other hand, when the images 101A and 101B represented in FIG. 4B are to be displayed, the images 101A and 101B are displayed in an alternating manner as represented in FIG. 5B. In addition, in accordance with the display of the images 100A and 100B, the liquid crystal shutter 200R opens the shutter at the time when the image 100A is displayed, and the liquid crystal shutter 200L opens the shutter at the time when the image 100B is displayed.

Next, the procedure at the time when the video display device 1 selects one of the operations represented in FIGS. 5A and 5B will be described.

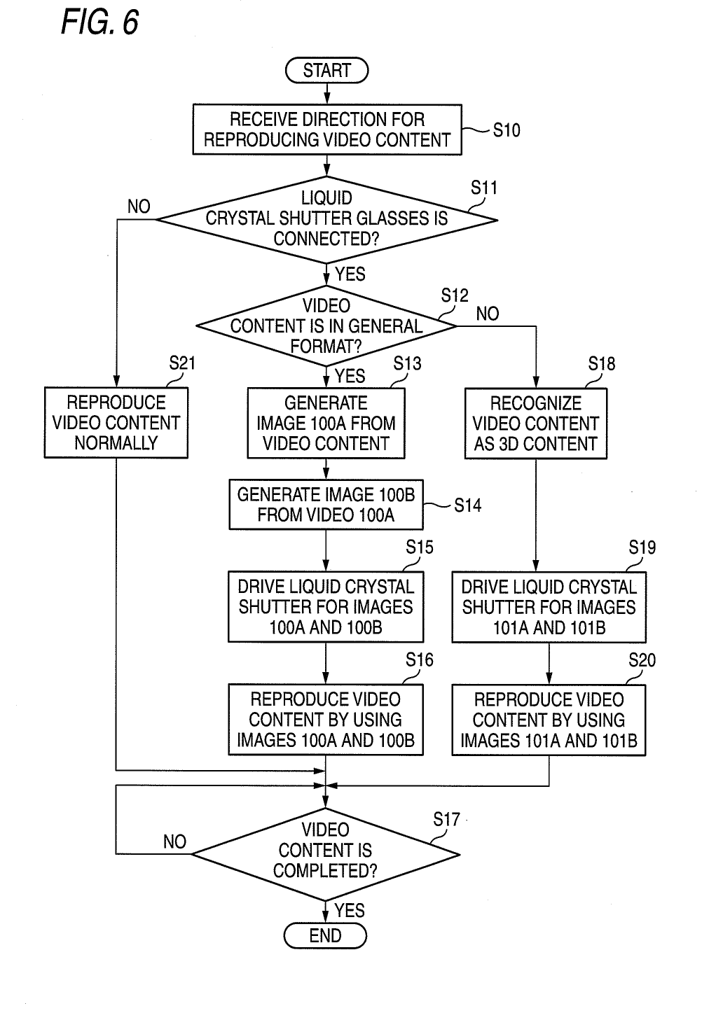

FIG. 6 is a schematic diagram representing an example of the operation of a video display device according to the embodiment of the present invention.

First, when the video reproducing module 11A receives a direction for reproducing the video content 12B (S10), the USB port connection detecting module 11E checks the connection status of the USB port 13.

When the liquid crystal shutter glasses are connected thereto (S11; Yes), the video reproducing module 11A checks whether the video content is a general format. When the video content is a general format (S12; Yes), the special video generating module 11B generates an image 100A as represented in FIG. 4A for every frame from the video content 12B (S13). Next, the special video generating module 11B generates an image in an inverted color from the image 100A and generates an image 100B by adding the random dots 100b thereto (S14).

Next, the liquid crystal shutter glasses control module 11D controls the liquid crystal shutters 200R and 200L as represented in FIG. 5A (S15). In addition, by controlling the display of the images 100A and 100B as represented in FIG. 5A, the video display control module 11C reproduces the video content (S16).

Next, when the reproduction of the video content 12B is completed (S17; Yes), the operation is completed.

On the other hand, when the video content 12B is not a general format (S12; No), the video reproducing module 11A recognizes the video content 12B as a 3D content (S18), and the liquid crystal shutter glasses control module 11D drives the liquid crystal shutter glasses 2 as represented in FIG. 5B (S19). In addition, the video display control module 11C controls the display of the images 101A and 101B that are included in the video content 12B as the 3D content (S20) as represented in FIG. 5B, and the process proceeds to Step S17.

In addition, when the liquid crystal shutter glasses 2 are not connected to the USB port 13 in Step S11 (S11; No), the video reproducing module 11A and the video display control module 11C operate in an ordinary manner so as to reproduce the video content 12B in accordance with the reproduction format (S21). Then, the process proceeds to Step S17.

According to the above-described embodiment, the method of reproducing the video and the method of operating the shutters of the liquid crystal shutter glasses 2 are configured to be changed based on the connection status of the liquid crystal shutter glasses 2 and the content of the video content 12B. Accordingly, display of an image including confidential information and display of an image including information other than the confidential information can be automatically switched back and forth without user's switching the display method.

In addition, the image 100B that includes the random dots 100b is configured to be generated at the time of displaying an image including confidential information. Accordingly, it is relatively difficult for a user to recognize the images 100A and 100B, compared to a case where the random dots 100b are not used. Furthermore, in order to make it more difficult to recognize the image 100A, the display time interval of the image 100B may be set to be longer than that of the image 100A.

The present invention is not limited to the above-described embodiment, and various changes may be made therein in the scope not departing from the present invention. For example, the invention is not limited to reproduction of the video content 12B. Thus, the invention may be applied to all the videos displayed by the OS or the like of a personal computer or a video, which is displayed within a part of the window, displayed by an application or the like. Furthermore, the video content 12B may be a motion picture or a still screen.

In addition, the video reproducing module 11A, the special video generating module 11B, the video display control module 11C, the liquid crystal shutter glasses control module 11D, and the USB port connection detecting module 11E that are used in the above-described embodiment may be read into a memory located inside the device from a memory medium such as a CD-ROM or may be downloaded into the memory located inside the device from a server or the like that is connected to a network such as the Internet. Furthermore, some or all of the means used in the above-described embodiment may be implemented by hardware such as an ASIC.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A video display device comprising:
a connection detecting module configured to detect whether a shutter glasses is connected to the device;
a generation module configured to generate a second frame alternately displayed with a first frame in a video content, by adding an irregular pattern to an image viewed in a predetermined color when the connection detecting module detects that the shutter glasses is connected;
a display configured to display the video content;
a video display controller configured to cause the display to alternately display the first frame and the second frame; and
a shutter glass controller configured to cause the shutter glasses to close shutters in synchronization with the time for displaying the second frame.

2. The video display device of claim 1,
wherein the video display controller is configured to cause the display to alternately display a third frame and a fourth frame in the video content when the video content is a stereoscopic video, and
wherein the shutter glasses controller is configured to cause the shutter glasses to alternately close the left and right shutters in synchronization with the time for displaying the third frame and the fourth frame.
